(19) United States
(12) Patent Application Publication
(10) Pub. No.: US 2018/0218835 A1
(43) Pub. Date: Aug. 2, 2018

(54) METHOD FOR PREPARING SINTERED RARE EARTH-BASED MAGNET USING MELTING POINT DEPRESSION ELEMENT AND SINTERED RARE EARTH-BASED MAGNET PREPARED THEREBY

(71) Applicant: INDUSTRY-UNIVERSITY COOPERATION FOUNDATION SUNMOON UNIVERSITY, Asan-si, Chungcheongnam-do (KR)

(72) Inventors: Tae Suk JANG, Cheonan-si, Chungcheongnam-do (KR); Min Woo LEE, Cheonan-si, Chungcheongnam-do (KR)

(21) Appl. No.: 15/748,104

(22) PCT Filed: Nov. 4, 2015
(86) PCT No.: PCT/KR2015/011766

§ 371 Date: Jan. 26, 2018

(30) Foreign Application Priority Data
Jul. 28, 2015 (KR) 10-2015-0106823

(51) Int. Cl. H01F 41/02; H01F 1/057; C22C 38/00

(52) U.S. Cl. CPC H01F 41/0293; B22F 2999/00; C22C 38/005; H01F 1/0577

(57) ABSTRACT

A method for preparing a sintered rare earth-based magnet using a melting point depression element and a sintered rare earth-based magnet prepared by the same are disclosed. The method for preparing a sintered rare earth-based magnet according to the present invention includes the steps of: heating an R—Fe—B based magnet powder to a predetermined temperature to produce a sintered magnet, in which R is a rare earth element or a combination of rare earth elements; coating the surface of the produced sintered magnet with a coating solution prepared by mixing a heavy rare earth powder and a melting point depression element powder in a solvent; and heat-treating the coated sintered magnet.

### TECHNICAL FIELD

The present invention relates to a method for preparing a sintered rare earth-based magnet, and more particularly, to a method for preparing a sintered rare earth-based magnet by applying the grain boundary diffusion in which a heavy rare earth element is coated on the surface of the sintered magnet to be diffused therein in order to improve coercive force of the sintered rare earth-based magnet.

### BACKGROUND ART

R—Fe—B based sintered rare earth-based magnet, where R is a rare earth element or a combination of rare earth elements such as neodymium (Nd), dysprosium (Dy), and terbium (Tb), is a permanent magnet which widely used in all industrial fields due to its excellent magnetic properties among permanent magnets such as Alnico, ferrite, and samarium-cobalt (SmCo₅).

In particular, there has been a rapid increase recently in the demand for hybrid/electric vehicle drive motors among the applications of sintered rare earth-based magnets. The R—Fe—B based sintered magnet with high magnetic energy is only an applicable magnet for hybrid/electric vehicle drive motors in which magnets are driven at a high temperature (200 to 220° C.). However, the R—Fe—B based sintered magnet has a low Curie temperature and a high temperature coefficient of coercive force (0.55%/° C.), thereby resulting in disadvantage that the coercive force significantly decreases at a high temperature. These disadvantages can be overcome by adding heavy rare earth elements (HREE) such as dysprosium (Dy) and terbium (Tb), which have a high anisotropy coefficient, thereby improving the coercive force.

Therefore, studies have been actively conducted to reduce the content of heavy rare earth element added to a sintered magnet to a minimum although the heavy rare earth element is added to the sintered magnet, thereby achieving a high efficiency compared to a use.

Specifically, since the grain size of the R—Fe—B based sintered magnet is much larger than the size of the single domain, and there is almost no histological change inside the grain, the coercive force depends on the ease of the reverse domain generation and movement. In other words, when the reverse domain generation and movement occur easily, the coercive force is low. If it is the opposite, the coercive force is high. Since the coercive force of the R—Fe—B based sintered magnet as described above is determined by the physical and histological characteristics at the grain boundary region, the coercive force can be improved by suppressing the reverse domain generation and movement at this region.

Therefore, a heavy rare earth element such as dysprosium (Dy) which is essentially added for improving the coercive force of the R—Fe—B based sintered magnet is intensively diffused only on the surrounding of grain boundary, in other words, on the surface of ferromagnetic crystal grain, thereby forming core-shell type structure in which the crystal grain is surrounded by layers with high magnetic anisotropy. Thus, it can obtain high coercive force, even though reducing its amount of use compared to adding the heavy rare earth element to be diffused evenly throughout the magnet in the conventional mother alloy melting process.

One of the methods attempted to obtain such a structure is the grain boundary diffusion process (GBDP), which utilizes a very large chemical reactivity at the interphase in the sintered magnet. Thus, the heavy rare earth element is coated on a surface of the sintered magnet. Then, for grain boundary diffusion along grain boundary by heat-treatment, pure metal or compound is coated or deposited on a surface of the magnet by sputtering or electrolytic depositing, or the heavy rare earth element is evaporated to enable surface diffusion. However, since the density of the sintered magnet being prepared is more than 90%, which is almost completely densified, the heavy rare earth element is hardly diffused to the inner center of the magnet.

The related prior art is disclosed in Korean Patent Registration No. 10-1516567 (entitled “Re—Fe—B based rare earth magnet by grain boundary diffusion of heavy rare earth and manufacturing methods thereof,” registered on May 15, 2015).

### DISCLOSURE

### Technical Problem

An object of the present invention is to provide a method of preparing a sintered rare earth-based magnet capable of efficiently diffusing a heavy rare earth element on the interphase of the sintered magnet, thereby enhancing the coercive force of the sintered magnet.

### Technical Solution

The objectives are achieved by a method for preparing a sintered rare earth-based magnet using a melting point depression element and a sintered rare earth-based magnet prepared thereby, in which the method includes the steps of: heating an R—Fe—B based magnet powder to a predetermined temperature to produce a sintered magnet, in which R is a rare earth element or a combination of rare earth elements; coating a surface of the produced sintered magnet with a coating solution prepared by mixing a heavy rare earth-based powder and a melting point depression element powder in a solvent; and heat-treating the coated sintered magnet.

Preferably, the heavy rare earth-based powder may be provided as a heavy rare earth-based compound, and the heavy rare earth-based compound may be an R—X compound (R is at least one heavy rare earth element such as Dy and Tb, and X is at least one heavy rare earth element such as H, O, N, F, and B).

Preferably, the heavy rare earth-based powder may be provided as a heavy rare earth-based alloy powder, and the heavy rare earth-based alloy powder may be an R-TM(-X) alloy powder (R is at least one heavy rare earth element such as Dy and Tb, TM is at least one transition metal, and X is B, C).

Preferably, the melting point depression element powder may include copper powder or aluminum powder.

Preferably, the heavy rare earth-based powder may be DyH₂ powder, and the melting point depression element powder may be copper powder in the coating solution. The coating solution may include 20 to 60% by weight of the DyH₂ powder and 3 to 6% by weight of the copper powder with respect to the total weight of the coating solution.

Preferably, the heavy rare earth-based powder may be DyH₂ powder, and the melting point depression element powder may be aluminum powder in the coating solution. The coating solution may include 20 to 60% by weight of the DyH₂ powder and 3 to 6% by weight of the aluminum powder with respect to the total weight of the coating solution.

Preferably, the step of heat-treating may include a first heat-treating at a first heat-treating temperature range of 790 to 910° C.

Preferably, the step of heat-treating may include a second heat-treating at a second heat-treating temperature range of 450 to 550° C. after the first heat-treating.

### Advantageous Effects

In application of the grain boundary diffusion in which a heavy rare earth element is coated on the surface of the sintered magnet to be diffused therein in order to improve coercive force, the present invention is such that a melting point depression element is added in a coating solution for coating the heavy rare earth element on the surface of the sintered magnet, thereby improving the diffusion depth of the heavy rare earth element so as to enhance the coercive force.

### DESCRIPTION OF DRAWINGS

FIG. 1 illustrates a schematic flowchart of a method for preparing a sintered rare earth-based magnet using a melting point depression element according to an embodiment of the present invention.

FIG. 2 illustrates a schematic view for explaining the step of producing a coating solution according to FIG. 1.

FIG. 3 illustrates a flowchart for explaining the step of heat-treating according to FIG. 1.

FIG. 4 illustrates a mapping image comparing before and after the addition of copper powder and aluminum powder to the coating solution according to FIG. 2.

FIG. 5 illustrates a demagnetizing curve showing the change of the coercive force of the sintered magnet according to the temperature per the coating solution component after the first heat-treating for the coated sintered magnet.

FIG. 6 illustrates a mapping image comparing the diffusion depths and diffusion behaviors of sintered magnets coated with different coating solutions according to FIG. 5.

FIG. 7 illustrates a mapping image showing an internal microstructure of a sintered magnet in a state where copper powder and aluminum powder are added.

FIG. 8 illustrates a time-temperature graph showing the reason that copper powder and aluminum powder have different diffusion depths in a sintered magnet.

### MODE OF INVENTION

The advantages and/or features of the present invention and the method for achieving the same will become apparent from the detailed description of the following embodiments in conjunction with the accompanying drawings. However, it should be understood that the present invention is not limited to the following embodiments and may be embodied in different ways, and that the embodiments are provided for complete disclosure and a thorough understanding of the present invention by those skilled in the art. The scope of the present invention is defined only by the claims. The same reference numbers indicate the same components throughout the specification. However, in the following description of the present invention, well-known functions or constructions are not described in order to avoid unnecessarily obscuring the subject matter of the present invention.

Prior to the explanation, rare earth elements such as neodymium (Nd), dysprosium (Dy), and terbium (Tb) may be selectively used for the sintered rare earth-based magnet according to the present invention. However, in an experimental example to explain and support the present invention, an Nd—Fe—B based sintered magnet using neodymium (Nd) will be described as an example.

The method of preparing a sintered rare earth-based magnet using a melting point depression element according to the present invention employs the grain boundary diffusion process (GBDP) in which a surface of the sintered magnet having been sintered is coated with a coating solution containing a heavy rare earth element, and then the heavy rare earth element is diffused. Through this method, the core-shell type structure is formed in which the heavy rare earth element is richly present on the outer area of the primary phase on the surface of the sintered magnet.

Here, in order to improve the diffusion depth of the heavy rare earth element in the sintered magnet, the present invention uses a coating solution added with a melting point depression element for lowering the melting point of the interphase of the sintered magnet in the application of the grain boundary diffusion process to the sintered magnet. In other words, according to the present invention, a melting point depression element in a powder form and a heavy rare earth powder together are mixed in a coating solution, the coating solution is used for coating the surface of the sintered magnet, and then a predetermined heat-treating is performed. By such a process, the melting point depression element decreases a melting point of the interphase of the sintered magnet, thereby more enhancing the diffusion depth of a heavy rare earth element included in the heavy rare earth-based powder in the sintered magnet.

For reference, the term “interphase (grain boundary)” in this specification also means 2nd phase surrounding a primary phase (that is, 1st phase), a Nd-rich phase or a triple junction phase.

Accordingly, in the method of preparing a sintered rare earth-based magnet using a melting point depression element according to the present invention, the heavy rare earth element is uniformly diffused into a sintered magnet along a grain boundary so that ferromagnetic grain boundary is surrounded by layers with high magnetic anisotropy to increase the diffusion depth, thereby enhancing the coercive force.

Hereinafter, a method of preparing a sintered rare earth-based magnet using a melting point depression element according to the present invention will be described in detail with reference to FIGS. 1 to 3.

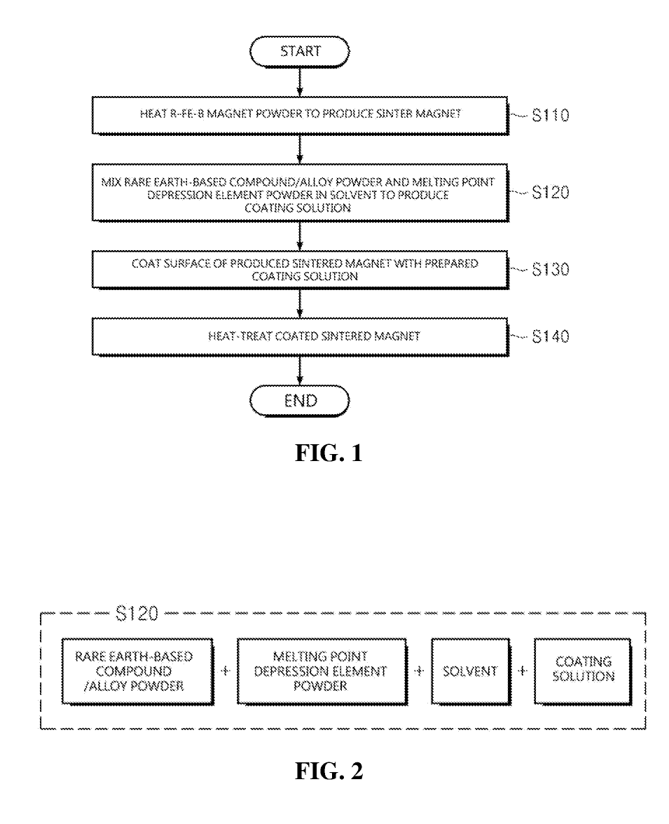

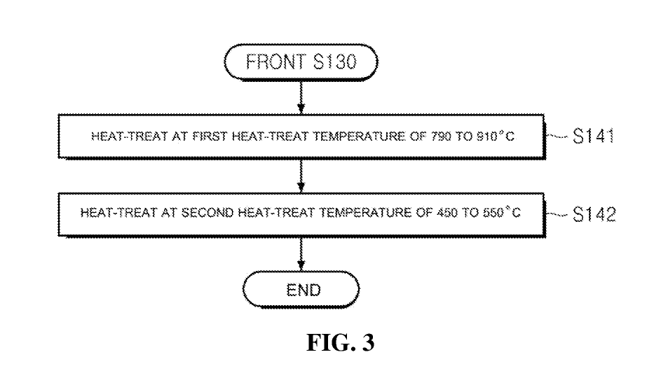

FIG. 1 illustrates a schematic flowchart of a method of preparing a sintered rare earth-based magnet using a melting point depression element according to an embodiment of the present invention. FIG. 2 illustrates a schematic view for describing the step of producing a coating solution in FIG. 1. FIG. 3 illustrates a flowchart for describing the step of heat-treating in FIG. 1.

As illustrated in FIG. 1, a method of preparing a sintered rare earth-based magnet using a melting point depression element according to the present invention may include the step S110 of heating R—Fe—B based magnet powder (where R is a rare earth element or a combination of rare earth elements) to a predetermined temperature to produce a sintered magnet, the step of S130 of coating a surface of the produced sintered magnet with a coating solution prepared by mixing a heavy rare earth-based powder and a melting point depression element powder in a solvent, and the step S140 of heat-treating the coated sintered magnet. Here, the present invention may further include the step S120 of producing the coating solution in which the heavy rare earth-based powder and the melting point depression element powder are mixed in a solvent. First, the step S110 is performed in which R—Fe—B based magnet powder is heated to the predetermined temperature to produce the sintered magnet. Here, the R—Fe—B based magnet powder may be prepared by producing an alloy strip, subjecting the produced alloy strip to hydrogen treatment and dehydrogenation treatment, and pulverizing the result. Here, the magnet powder is ground to a predetermined size or less for a use, and the pulverizing process may be performed by a fine pulverizer such as a jet mill or a ball mill. Meanwhile, the predetermined temperature, in other words, a sintering temperature, is preferably in the range of 1000 to 1100° C.

Next, the step S120 is performed in which the coating solution is produced by mixing the heavy rare earth powder and the melting point depression element powder in a solvent.

The heavy rare earth powder used in the step S120 of producing the coating solution of the present invention may be selectively used as a heavy rare earth-based compound or a heavy rare earth-based alloy powder. Here, the heavy rare earth-based compound may be provided as an R—X compound (R is at least one heavy rare earth element such as Dy and Tb, and X is at least one heavy rare earth element such as H, O, N, F, and B), and the heavy rare earth-based alloy powder may be provided as an R-TM(-X) alloy powder (R is at least one heavy rare earth element such as Dy and Tb, TM is at least one transition metal, and X is B, C). In particular, the heavy rare earth powder is preferably provided as a dysprosium hydride powder (DyH₂ powder) among heavy rare earth-based compounds, but the present invention is not limited thereto.

The melting point depression element powder is preferably provided as copper powder or aluminum powder. The melting point depression element is an element that lowers the melting point of the interphase (grain boundary) of the sintered magnet in order to improve the diffusion depth of the heavy rare earth element in the sintered magnet when the grain boundary diffusion process is applied to the sintered magnet. The term “interphase” refers to 2nd phase which is the outer area of the primary phase, which is surrounding the primary phase (that is, 1st phase) of the sintered magnet, and may be referred to as an Nd-rich phase in one embodiment of the present invention.

In the present invention, the melting point depression element should be selected in consideration of a relatively low melting point as compared with the sintered magnet, no negative influence on other magnetic characteristics of the sintered magnet, and solubility with the primary phase. Based on such selection criterion, copper (Cu) or aluminum (Al) is considered to be the most suitable melting point depression element in the present invention. In the present invention, the surface of the sintered magnet is coated by a coating solution prepared by mixing the heavy rare earth powder and the melting point depression element in a form of powder together in a solvent, and then a predetermined point of heat treatment is performed so that the melting point depression element lowers a melting point of the interphase of the sintered magnet, thereby being capable of significantly enhancing the diffusion depth of the heavy rare earth element, for example, dysprosium (Dy), which is included in the heavy rare earth powder, in the sintered magnet.

In other words, the melting point depression element acts as a carrier by lowering the melting point of the interphase surrounding the primary phase of the sintered magnet and thus by diffusing dysprosium (Dy) added to the heavy rare earth powder to the inside of the magnet, so as to enhance the coercive force. The reason for this phenomenon is why in the step S140 of heat-treating, the coating solution to which the melting point depression element is added lowers the melting point of the interphase so that the liquid phase is formed more rapidly, and thus the microstructure of the sintered magnet is improved, thereby increasing the diffusion depth of dysprosium (Dy).

The solvent plays a role of dissolving and mixing the heavy rare earth powder and the melting point depression element powder. At this time, anhydrous alcohol may be used as the solvent, but the present invention is not limited thereto. In addition, the surface of sintered magnet is coated with the solvent mixed with the heavy rare earth powder and the melting point depression element powder, and then the solvent may be dried and removed in a vacuum state.

Meanwhile, the coating solution according to the present invention preferably includes 20 to 60% by weight of DyH₂ powder and 3 to 6% by weight of copper powder with respect to the total weight thereof or 20 to 60% by weight of DyH₂ powder and 3 to 6% by weight of aluminum powder with respect to the total weight thereof. In other words, copper powder or aluminum powder is preferably added in a weight ratio of 0.01 to 0.04 with respect to DyH₂ powder in the coating solution according to the present invention.

Next, the step S130 of coating the surface of the sintered magnet with the coating solution prepared in the preceding step S120 is performed. In other words, in the step S130, the surface of the sintered magnet is coated with the coating solution prepared by mixing heavy rare earth powder and melting point depression element powder into the solvent. For example, the surface of the sintered magnet may be coated by a dipping method in which the sintered magnet is dipped in the coating solution and then taken out and dried. However, various coating methods other than the dipping method may also be applied to the step S130 of coating in the present invention.

Lastly, the step S140 of heat-treating on the sintered magnet coated in the preceding step S130 is performed. Here, the step of heat-treating S140 may include the step S141 of performing a first heat-treating at a first heat-treating temperature range of 790 to 910° C. and the step S142 of performing a second heat-treating at a second heat-treating temperature range of 450 to 550° C. after the step S141 of the first heat-treating.

Here, the step of first heat-treating (S141) preferably has a range of 790 to 910° C., and the step of second heat-treating (S142) preferably has a range of 450 to 550° C. This is because the diffusion of heavy rare earth elements contained in the heavy rare earth powder on the surface of the sintered magnet proceeds smoothly in this temperature range. In other words, the step S140 of heat-treating of the present invention can perform the heat treatment of the sintered magnet coated in the step S130 of coating.

Specifically, in the step S140 of heat-treating, a heavy rare earth element, that is, dysprosium (Dy) may be diffused along an interface having large chemical reactivity by heat-treating the coated sintered magnet.

In the foregoing, a method of preparing the sintered rare earth-based magnet using the melting point depression element according to the present invention has been described, and the present invention may include a sintered rare earth-based magnet prepared by the method as described above.

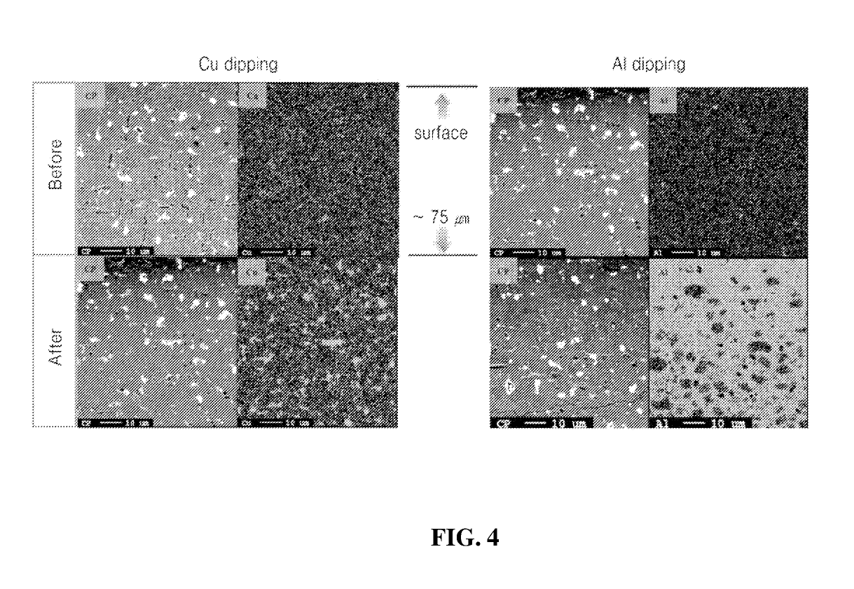

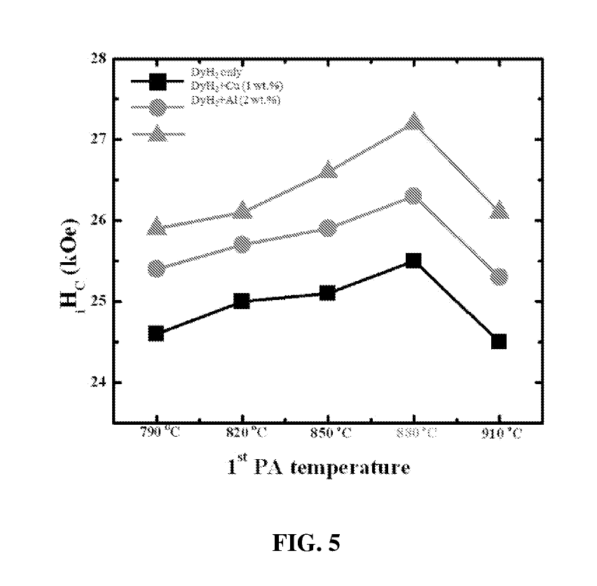

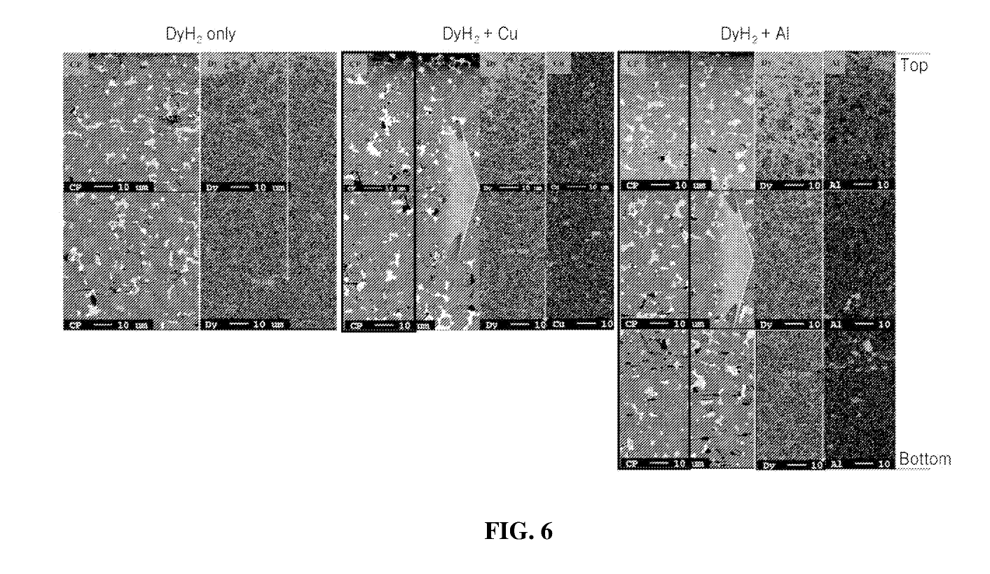

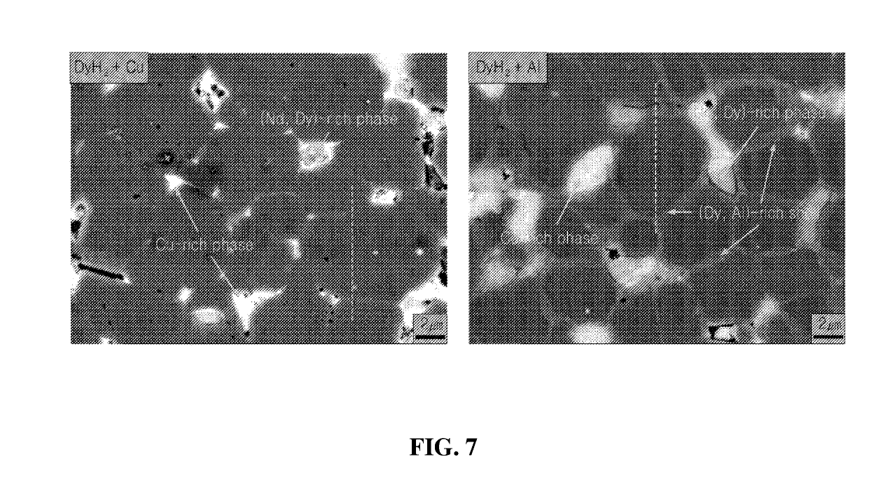

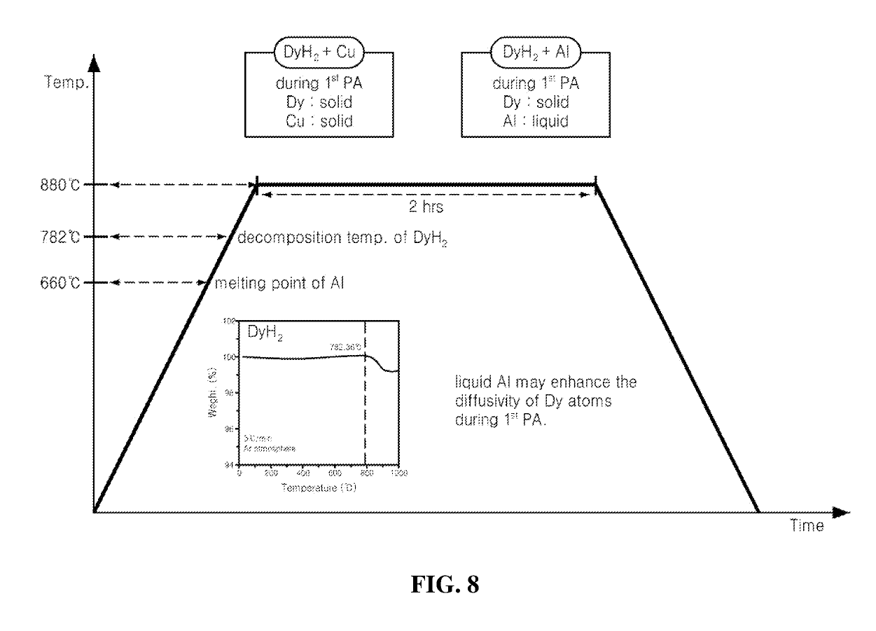

Hereinafter, the operational effect of the method of preparing the sintered magnet using the melting point depression element according to the present embodiment will be described in detail through experimental embodiments with reference to experimental embodiments FIGS. 4 to 8. FIG. 4 illustrates a mapping image comparing before and after the addition of copper powder and aluminum powder to the coating solution according to FIG. 2. FIG. 5 illustrates a demagnetizing curve showing the change of the coercive force of the sintered magnet according to the temperature per the coating solution component after the first heat-treating for the coated sintered magnet. FIG. 6 illustrates a mapping image comparing the diffusion depths and diffusion behaviors of sintered magnets coated with different coating solutions according to FIG. 5. FIG. 7 illustrates a mapping image showing an internal microstructure of a sintered magnet in a state where copper powder and aluminum powder are added. FIG. 8 illustrates a time-temperature graph showing the reason that copper powder and aluminum powder have different diffusion depths in the sintered magnet.

### EXPERIMENTAL EXAMPLE

(1) Experimental Method

In this experiment, an alloy having a composition of 29.00Nd, 3.00Dy, bal.Fe, 0.97B, and 2.39M was dissolved and rapidly cooled through a strip caster to prepare an alloy strip. The prepared alloy strip was hydrogenated at 400° C. for 2 hours under a hydrogen pressure of 0.12 MPa and then heated in a vacuum to remove hydrogen. The hydrogenated/dehydrogenated alloy strip was milled at 6000 rpm using a jet mill to prepare magnet powder. The mixed powder was uniaxial magnetic field-molded under a magnetic field of 2.2 T and then was vacuum-sintered at 1060° C. for 4 hours to produce a sintered magnet. Then, a coating solution as Example 1 was prepared by mixing 1.0 g of DyH₂ powder and 0.01 to 0.04 g of copper powder, which is melting point depression element, in the ethanol. A coating solution as Example 2 was prepared by mixing 1.0 g of DyH₂ powder and 0.01 to 0.04 g of aluminum powder, which is melting point depression element, in the ethanol. A coating solution as Comparative Example 1 was prepared by mixing 1.0 g of DyH₂ powder in the ethanol.

The sintered magnet was dipped in each of the prepared coating solutions in Example 1, Example 2, and Comparative Example 1, dried, and subjected to the first heat-treating at 790 to 910° C. for 2 hours, followed by the second heat-treating at 500° C. for 2 hours. Here, each first heat-treating on Example 1, Example 2, and Comparative Example 1 was performed at each of 850° C., 880° C., and 910° C.

Here, the distribution of copper, aluminum, and dysprosium (Dy) (the shape and distribution of the powder produced and the microstructure of the sintered body) was observed through an electron probe micro-analyzer (EPMA). The magnetic properties of the sintered magnet were observed using a B-H loop tracer (Magnet physik Permagraph C-300).

Through these experiments, while the dysprosium (Dy) compound was simply deposited to the sintered magnet, and then the grain boundary diffusion occurred through the heat treatment, it was attempted to improve the diffusion depth of dysprosium (Dy) by adding a melting point depression element. The microstructure and magnetic properties of the sintered magnet were examined. Those will be described in detail with reference to experimental data as described below.

Example 1: Coating solution prepared by mixing 1.0 g of DyH₂ powder and 0.01 to 0.04 g of copper powder in ethanol as a solvent

Example 2: Coating solution prepared by mixing 1.0 g of DyH₂ powder and 0.01 to 0.04 g of aluminum powder in ethanol as a solvent

Comparative Example 1: Coating solution prepared by mixing 1.0 g of DyH₂ powder in ethanol as a solvent

(2) Analysis of Experimental Results

FIG. 4 illustrates a mapping image showing before and after the heat-treatment, in which copper and aluminum elements in Nd—Fe—B based sintered magnet are dipped in the coating solution in order to compare them. As illustrated in the left image of FIG. 5, it can be seen that the copper element is mainly distributed in the interface and the triple junction phase (TJP). Further, as illustrated in the right image of FIG. 5, it can be seen that when the aluminum element is diffused along the interface, the aluminum element is also partially diffused in outer area of the primary phase, thereby forming core-shell type structure. It was confirmed that the reason why the core-shell type structure is formed only for the aluminum element is that the copper has no solubility with Fe in the primary phase, but aluminum has some solubility with the primary phase in the case of aluminum.

TABLE 1

| H.T. | | B₁ | ᵢH_{c} | (BH)ₘₐₓ | ᵢH_{c}+ |
|---|---|---|---|---|---|
| (° C.) | Dipping Sol. | (kG) | (kOe) | (MGOe) | (BH)ₘₐₓ |
| 850 | Un-dipped | 13.0 | 22.3 | 42.2 | 64.5 |
| | DyH₂ + Cu | 12.9 | 25.9 | 41.5 | 67.4 |
| | DyH₂ + Al | 12.9 | 26.6 | 41.3 | 67.9 |
| | DyH₂ | 12.8 | 25.1 | 40.9 | 66.0 |
| 880 | Un-dipped | 13.0 | 22.5 | 42.3 | 64.8 |
| | DyH₂ + Cu | 12.9 | 26.3 | 41.1 | 67.4 |
| | DyH₂ + Al | 12.9 | 27.2 | 41.3 | 68.6 |
| | DyH₂ | 12.9 | 25.5 | 40.9 | 66.8 |
| 910 | Un-dipped | 12.9 | 21.7 | 42.0 | 63.7 |
| | DyH₂ + Cu | 12.8 | 25.3 | 41.4 | 66.7 |
| | DyH₂ + Al | 12.9 | 26.1 | 41.7 | 67.8 |
| | DyH₂ | 12.9 | 24.5 | 41.8 | 66.3 |

As illustrated in FIG. 5, referring to the demagnetizing curve showing the change of the coercive force of the sintered magnet according to the first heat treatment temperature, the first heat treatment was fixed at each of 850° C., 880° C., and 910° C. The result of the experiments was shown in Table as described above.

When compiling Table 1 according to the experiments and then showing the same in a graph, the demagnetizing curve is drawn up, which shows the change of coercive force of the sintered magnet according to a temperature of each component of the coating solution after the first heat treatment on the coated sintered magnet as illustrated in FIG. 6.

Referring to FIG. 5, the most excellent coercive force was obtained when the step S141 of first heat-treating was performed at 880° C. Further, for the sintered magnet heat-treated at 880° C., the coercive force of 3.0 kOe was measured when heat-treating after addition of the coating solution of Comparative Example 1, the coercive force of 3.8 kOe was measured when heat-treating after addition of the coating solution of Example 1, and the coercive force of 4.7 kOe was measured when heat-treating after addition of the coating solution of Example 2. Those indicate that the coercive force is further increased when the melting point depression element is added as in Example 1 and Example 2, as compared with the case of the coating solution of Comparative Example 1, that is, the melting point depression element is not added. In particular, it can be seen that the coercive force is further increased when aluminum is added to the coating solution compared to copper, in other words, when Example 2 rather than Example 1.

Further, when the coated sintered magnet was tested with different first heat treatment temperatures, it was found that the coercive force obtained by performing at the first heat treatment temperature of 880° C. was greater than that at 850° C. or 910° C. Further, the coercive force obtained by adding the melting point depression element (Examples 1 and 2) was increased compared to that without the melting point depression element (Comparative Example 1). It is determined that the melting point depression element powder plays a role of lowering the melting point of Nd-rich phase, thereby diffusing the heavy rare earth element on the surface of the sintered magnet powder.

FIG. 6 illustrates an image obtained by mapping the sintered magnet grain-boundary-diffused under three different conditions in which components of the coating solution are different, that is, coating solutions of Example 1, Example 2, and Comparative Example 1. This reveals the diffusion depth of dysprosium (Dy) in three different conditions. Specifically, in the case of the coating solution of Comparative Example 1, the diffusion depth of dysprosium (Dy) is about 90 μm. In the case of the coating solution of Example 1, the diffusion depth of dysprosium (Dy) is 150 μm which is slightly more improved. As the diffusion depth of dysprosium (Dy) increases, the coercive force increases. Those are consistent with results from Table 1 as described above. Particularly, in the case of the coating solution of Example 2, the diffusion depth was 525 μm, which is about 6 times higher than that of Comparative Example 1.

FIG. 7 illustrates a high-magnification image showing the internal microstructure of the sintered magnet to which coating solutions of Examples 1 and 2 are added. As described above, for addition of copper powder and aluminum powder, both effects are different from each other because there are different diffusion behaviors in the sintered magnet as above-described FIG. 6. Further, in the case of copper, there is no solubility with the primary phase, and it is difficult to diffuse dysprosium (Dy) into the primary phase. However, since aluminum has solubility with the primary phase, it contributes to diffusion of dysprosium (Dy) into the magnet, thereby diffusing dysprosium (Dy) to the outer area of the primary phase to form a core-shell type structure.

In other words, as illustrated in FIG. 8, the copper powder and aluminum powder have different diffusion depths in the sintered magnet because copper exists in a solid phase within a range of the first heat-treating temperature, but aluminum exists in a liquid phase within a range of the first heat-treating temperature. Specifically, aluminum is present in the liquid phase within a range of the first heat-treating temperature, while it reacts more actively with the Nd-rich phase to assist diffusion of dysprosium (Dy) to be deeply diffused into the magnet. However, since copper exists in a solid phase within a range of the first heat-treating temperature, it does not greatly assist in the diffusion of dysprosium (Dy).

Therefore, the melting point depression element such as copper or aluminum is added to uniformly diffuse the heavy rare earth element into the sintered magnet along the grain boundaries so that the ferromagnetic grains are surrounded by layers having high magnetic anisotropic, thereby increasing the diffusion depth and enhancing the coercive force. Here, when the aluminum is added rather than the copper, that is, Example 2 rather than Example 1, dysprosium (Dy) is deeply diffused to the inside of the fully densified magnet, thereby obtaining large coercive force.

Although the present invention has been described with reference to only limited exemplary embodiments and drawings as described above, it is to be understood by those skilled in the art that the present invention may include various modifications and variations therefrom. Therefore, it is to be understood that the spirit of the present invention is solely defined by the appended claims, and all of the equivalent or equivalent variations thereof fall within the scope of the present invention.

### INDUSTRIAL AVAILABILITY

The present invention can be applied to various industries including a motor for an electric vehicle and the like in which a sintered rare earth-based magnet is used.

1. A method for preparing a sintered rare earth-based magnet using a melting point depression element, the method comprising the steps of:
heating an R—Fe—B based magnet powder to a predetermined temperature to produce a sintered magnet, in which R is a rare earth element or a combination of rare earth elements;
coating a surface of the produced sintered magnet with a coating solution prepared by mixing a heavy rare earth-based powder and a melting point depression element powder in a solvent; and
heat-treating the coated sintered magnet.

2. The method of claim 1, wherein the heavy rare earth-based powder is provided as a heavy rare earth-based compound, and
wherein the heavy rare earth-based compound is an R—X compound (R is at least one heavy rare earth element such as Dy and Tb, and X is at least one heavy rare earth element such as H, O, N, F, and B).

3. The method of claim 1, wherein the heavy rare earth-based powder is provided as a heavy rare earth-based alloy powder, and
wherein the heavy rare earth-based alloy powder is an R-TM(-X) alloy powder (R is at least one heavy rare earth element such as Dy and Tb, TM is at least one transition metal, and X is B, C).

4. The method of claim 1, wherein the melting point depression element powder includes copper powder.

5. The method of claim 1, wherein the melting point depression element powder includes aluminum powder.

6. The method of claim 1, wherein the heavy rare earth-based powder is DyH₂ powder, and the melting point depression element powder is copper powder in the coating solution.

7. The method of claim 6, wherein the coating solution includes 20 to 60% by weight of the DyH₂ powder and 3 to 6% by weight of the copper powder with respect to the total weight of the coating solution.

8. The method of claim 1, wherein the heavy rare earth-based powder is DyH₂ powder, and the melting point depression element powder is aluminum powder in the coating solution.

9. The method of claim 8, wherein the coating solution includes 20 to 60% by weight of the DyH₂ powder and 3 to 6% by weight of the aluminum powder with respect to the total weight of the coating solution.

10. The method of claim 1, wherein the step of heat-treating includes a first heat-treating at a first heat-treating temperature range of 790 to 910° C.

11. The method of claim 10, wherein the step of heat-treating includes a second heat-treating at a second heat-treating temperature range of 450 to 550° C. after the first heat-treating.

12. A sintered rare earth-based magnet produced by the method of claim 1.
